(19) United States
(12) Patent Application Publication
(10) Pub. No.: US 2026/0216771 A1
(43) Pub. Date: Jul. 30, 2026

(54) Method and Composition for the Remediation of Contaminants

(71) Applicants: Larry Kinsman, Verona, WI (US); Adam Mohs, Sartell, MN (US); Orin Technologies, LLC, Verona, WI (US)

(72) Inventors: Larry Kinsman, Verona, WI (US); Adam Mohs, Sartell, MN (US)

(21) Appl. No.: 19/137,196

(22) PCT Filed: Dec. 7, 2023
(86) PCT No.: PCT/US2023/082814

§ 371 Date: Jun. 9, 2025

Related U.S. Application Data
(60) Provisional application No. 63/431,068, filed on Dec. 8, 2022.

(51) Int. Cl. B09C 1/00; B09C 1/08; B09C 1/10; C02F 3/02; C02F 3/34; C02F 103/06

(52) U.S. Cl. CPC B09C 1/002; B09C 1/08; B09C 1/10; C02F 3/02; C02F 3/341; B09C 2101/00; C02F 2103/06

(57) ABSTRACT

The present application is directed to a method of remediation of contaminants through the formation of a treatment zone defined by an introduction of biochar, an aerobic contaminate degrading bacteria, and sufficient oxygen sources to maintain aerobic conditions for contaminant degradation by microbial activity in the treatment zone. The present application may be applied to in situ or ex situ contaminant remediation.

### BACKGROUND OF THE INVENTION

The present invention relates to a method and composition for remediating contaminants from soil, groundwater, leachates, wastewaters, and surface waters, and more specifically, the present invention describes a method and composition for remediation of contaminants through the administration of a composition including a biochar, microbial seeding, and oxygen sources, wherein the biochar is both an absorbent medium and a biological growth medium for the metabolic removal of contaminants.

The discharge of organic compounds and other contaminants into the soil and surface water can lead to contamination of surface and groundwater sources resulting in potential public health impacts. Treatment of such wastewater and the remediation of soils and groundwater contaminated with organic compounds and other contaminants has been expensive, requires considerable time, and in many cases are incomplete or unsuccessful.

Many different physical techniques and methods exist for the remediation of soil, groundwater and wastewater to meet the clean-up standards. Examples include dig-and-haul, pump-and-treat, biodegradation, sparging, and vapor extraction. However, meeting stringent clean-up standards is often costly, time-consuming, and often ineffective for many compounds that are recalcitrant, i.e., not responsive to such treatment. Such drawbacks arc particularly true of techniques that require contaminated areas to be removed prior to treatments, i.e., ex situ methods, such as is dig-and-haul and pump-and-treat methods. Accordingly, there is a need for an effective method and composition for remediation that treats contaminates in place, i.e., in situ, and does not require movement or prior extraction of the contaminated environmental media prior to treatment.

Treatment of highly soluble but historically biologically stable organic contaminants such as Perfluoroalkyl/Polyfluoroalkyl Substances (PFAS) have also been shown to be quite difficult with conventional remediation technologies and wastewater treatment. This is particularly true as these compounds are difficult to degrade chemically, thermally, and biologically is all environments. Accordingly, sorbative remediation methods, both in situ and ex situ have become prevalent.

Biochar has been shown to be an effective ex situ treatment for various contaminants such as agricultural runoff containing nitrates, phosphates, and ammonia, mine drainage and tailings containing various heavy metals and low pH, municipal storm water, general heavy metals removal and general organic compounds. Likewise, biochar has been shown to be an effective environmental remediation tool for the remediation of contaminated soil and groundwater, whether by itself, embedded, or in conjunction with other treatments such as, reductive remediation methods (ZVM) (ZVI) and/or carbon sources, oxidative remediation methods, metal stabilization methods or combinations thereof occurring simultaneously or sequentially and the delivery of such systems by injection methods.

However, concerns related to the rerelease of contaminants into the environment from sorbative materials such as activated carbon and biochar and the disposal issues created by regeneration of other sorbative media witch result in a aqueous streams with extreme concentrations of contaminant dictate the need to for effective degradation methods that take advantage of the contaminant concentrating nature of sorbative media, in particular, biochar. While oxidative examples exist, some contaminants are not responsive to such treatments. Biochar offers a unique substrate for biological growth making contaminant targeted biological treatment methods desirable.

### SUMMARY

The inventors have discovered that biochar, whether rendered injectable or used in unmilled format, can be combined with biological inoculation, and various oxygen sources is a highly effective method for remediation of various organic contaminants. Biochar maintains its sorbative properties removing contaminants from the surrounding media and concentrating them. Additionally, biochar creates a favorable substrate for biological growth promoting biological degradation of contaminants. Oxygen sources provide the necessary aerobic environment required to metabolize the targeted organic contaminants.

In one embodiment, the present invention provides a method of remediation of an organic contaminant including the steps of: (a) introducing a biochar in dry or slurry form into a subsurface, open pit, pond, container contamination zone comprising an organic contaminant; (b) forming a treatment zone defined by a location of the biochar slurry; (c) concentrating the organic contaminant from the contamination zone into the treatment zone; (d) inoculating the treatment zone with a biological agent capable of metabolizing the targeted contaminant, (e) introducing one or more oxygen sources into the treatment zone; and (f) metabolizing the organic contaminant at the treatment zone with aerobic metabolization to reduce a volume of the organic contaminant at the contamination zone.

The ability to introduce the biochar slurry into the subsurface is desirable because it allows for in situ remediation without the additional steps of removing contaminated environmental matter to be treated, and the related expense thereof.

Thus it is one object of the invention to provide a method wherein the biochar slurry comprises a mass of biochar particulates suspended in a volume of fluid carrier.

In one object of the invention a substantial portion of the biochar particles have a particle size of less than 50 microns as to facilitate its passage through a pumping apparatus, well, and/or subsurface penetration.

In one object of the invention a substantial portion of the biochar particles have a particle size of between 0.5 microns and 4000 microns as to facilitate its passage through a pumping apparatus, well, and/or subsurface penetration.

In another object of the invention a substantial portion of the biochar particles have a particle size of between 0.5 microns and 400 microns as to further facilitate its passage through a pumping apparatus, well, and/or subsurface penetration.

It is yet another object of the invention that the biochar constitute a growth substrate for biological growth.

The ability to introduce biochar directly to ponds, storage tanks, and other vessels while maintaining the ability for easy solids removal is desirable because it allows for ease of handling and the minimization of flocculating and coagulating agents and their associated costs.

Thus it is one object of the invention to provide a method that allows for direct addition of biochar particles.

In one object of the invention a substantial portion of the biochar particles have an average mean particle size range of approximately 15 microns as to facilitate solids removal and handling. As used herein, “approximately” means plus or minus 5%.

In one object of the invention, the biochar may include but is not limited to biochars formed from wood, grass, manure, grain husks, saw dust, etc. The biochars may be chars produced by conventional charring methods or, alternatively within the scope of this invention, the biochars may be produced with an additional activation step such as acid treatment, high pressure steam, etc. It is believed that the high surface are of the biochar component of the biochar slurry, as well as its molecular structure provides improved absorption of the organic contaminants relative to conventional activated charcoal. That is to say that the molecularly porous structure of biochar is configured to retain a larger volume of organic contaminants than is the relatively planner or flaky molecular structure of conventional activated carbon.

Additionally, it is further believed that the abundance of carboxyl groups located on the surface of the biochar facilitates in immobilizing otherwise free moving contaminates from the subsurface contamination zone. Resultantly, the biochar's concentration, i.e., adsorption, or organic contaminants such as hydrocarbons, even when such contaminants are present at low aqueous concentrations in the subsurface contamination zone results in the concentration of the contaminants which increases the residence time of the organic contaminant in the vicinity of the free radical as will be discussed below at length. This concentration may reduce the required volume of oxidizing agent significantly, and particularly in applications with low aqueous contaminant concentrations.

It is another object of the invention to provide a method of metabolizing an organic contaminant that has been concentrated at the treatment zone defined by the location of biochar.

Accordingly, the organic contaminant of the method may be PFAS compounds, PCBs, chlorinated solvents, or combinations of wherein the biochar absorbs the given organic contaminant.

In another object of the invention the present method reduces the percentage of a pre-remediation volume of the given organic contaminant at the contamination zone to an environmentally acceptable level.

In another object of the invention the present method may include the introduction of a biological inoculation into the treatment zone, including a biological nutrient media and a selected microbial agent.

In one object of the invention, the composition may also include a biochar slurry in which the biochar particulates are suspended in a fluid carrier.

In yet another object of the invention, the composition may also include a biological nutrient media and an anaerobic microbial agent.

In on object of the invention, the composition may include the introduction of an oxygen source into the contamination zone.

Accordingly, the oxygen sources of the method of may be selected from a group comprising peroxygens and/or oxygen electrically generated via electrodes placed within the treatment zone, or a combination thereof, air sparging or gas diffusion devices.

In still another object of the invention, the, the composition may also include a secondary oxidizing agent selected from a group comprising peroxygen, oxygen, or a combination thereof.

In still another object of the invention, electrodes may be placed at various intervals through the treatment zone with the intention of operating in such a way as to produce oxygen from various sources within the treatment zone. Sources may be naturally occurring or injected into the treatment zone.

In another aspect of the invention a combination of absorbent/adsorbent media combined with microbes and oxygen source to treat PFC's is provided. In one embodiment, oxygen source could be electrokinetic and electrochemical reactions and/or other oxygen sources like air sparging/venting, chemical additives or manual aeration. More specifically, an in-situ injection of a biochar, calcium peroxide, and PFAS degrading bacteria. Once the injection is complete an Electrokinetic system maybe activated in order to provide supplemental oxygen to the PFAS Degrading Bacteria.

Further aspects or embodiments of the present invention will become apparent from the ensuing description which is given by way of example only.

### BRIEF DESCRIPTION OF THE DRAWINGS

FIG. 1 is a site plan for treatment area according to one embodiment of the present invention; and,

FIG. 2 is cross-sectional front view of a monitoring well according to one embodiment of the present invention.

### DETAILED DESCRIPTION

The present disclosure provides a method. In an embodiment, the method of organic contamination remediation includes the steps of: forming a treatment zone in a contaminated area that contains an initial concentration of a perfluoroalkyl and/or polyfluoroalkyl substances (PFAS) and/or a perchloroethylene (PCE) contaminate. The treatment zone is defined by the introduction of treatment slurry comprising biochar and an aerobic contaminate degrading bacteria additive. The method includes supplying the treatment zone with an oxygen source. The contaminate is then concentrated at the surface of the biochar located in the treatment zone and degraded with the aerobic contaminate degrading bacteria additive to generate. The final concentration of the contaminate that is less than the initial concentration of the contaminate.

The process includes providing an oxygen source. The oxygen source is selected from a group consisting of peroxygens and/or oxygen electrically generated via electrodes placed within the treatment zone, air sparging, gas diffusion or a combination thereof. The electrode may further comprise an electrolysis and/or electokinetic system that may alternate and/or pulse at a duration of 0.1 ms to 10 s. A low operating voltage of approximately 1 to 100 volts, and preferably 10 to 40 volts is supplied throughout the electokinetic system. Optionally the electrokinetic system may further provide a low current density. IN a preferred embodiment the oxygen source is sufficient to maintain an aerobic environment in the treatment zone as to maintain the population of aerobic contaminate degrading bacteria.

The process includes degradation of a PFAS and/or PCE contaminate. In an embodiment the PFAS is selected from a group consisting of Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In an embodiment, the final concentration of the contaminate is less than 5% of the initial concentration. In an embodiment, the final concentration of the contaminate is less than 3% of the initial concentration. In an embodiment, the final concentration of the contaminate is less than 1% of the initial concentration. In an embodiment, the final concentration of the contaminate is less than the applicable regulatory threshold for groundwater and/or soil levels of PFAS and/or PCE.

The process includes providing and aerobic contaminate degrading bacteria additive. In an embodiment the aerobic contaminate degrading bacteria additive is selected from a group consisting of Pseudomonas, Rhodococcus, Pseudonocardia, Bacillus, Actinomycetota, and combinations thereof. In an embodiment the aerobic contaminate degrading bacteria additive bacteria comprises at least in-part an aerobic methanotrophic bacteria.

The process includes providing a biochar. In an embodiment the biochar is in slurry form that comprises from 2 wt %, or 4 wt %. or 6 wt %, or 8 wt % or 10 wt % to 12 wt %, or 13 wt %, or 15 wt %, or 17 wt %, or 20 wt %, or 25 wt % biochar based on the total weight of the slurry. In an embodiment, the biochar is formed of a plurality of particles having a net surface area of greater than or equal to 500, or 600, or 700, or 800, or 900, 1000 square meters per gram and less than or equal to 1,200, or 1,400, or 1,500 or 1,700, or 2,000 or 2,200 square meters per gram. In an embodiment the biochar particles have a particle size of between 0.5 microns or 1 micron, or 2 microns, or 5 microns, or 10 microns, or 25 microns, or 40 microns and 2000 microns, or 3000 microns, or 4000 microns, or 5000 microns. In an embodiment the slurry is a dilution comprising between 2%, or 4%, or 7.5%, or 9% and 9.5%, or 10%, or 12.5%, or 15% or 20% combined biochar and the aerobic contaminate degrading bacteria additive suspended in a fluid carrier based on the total volume of the slurry. In an embodiment the fluid carrier is water.

In an embodiment the treatment zone is an in situ treatment zone. The in situ treatment zone may further define a bioreactor including a plant, such as a tree planted in or above the treatment zone, such that the plant or tree is configured to capture mobile short chain compounds, i.e., (C<4).

### EXAMPLES

### I. Example 1—Aqueous Film Forming Foam Testing

a. Test Procedure

A significant source of PFAS contamination within soil and groundwater is the use of Aqueous Film Forming Foam (AFFF) as a fire suppressant to extinguish flammable liquid fires such as fuel fires in aviation and roadside scenarios. Firefighting training facilities have seen heavy and repeated application of these substances during training exercises over the course of several decades. These activities have produced a large number of sites requiring treatment of high concentrations of PFAS chemicals and their precursor compounds.

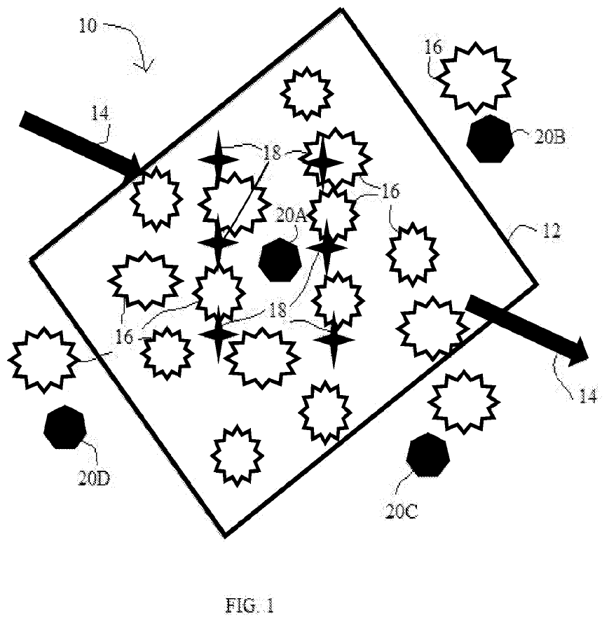

The inventors employed an embodiment of the invention to a small area of one such AFFF contamination site. As shown in FIG. 1, a treatment area 12 roughly 40′×40′ was designated for treatment within a portion of one such AFFF contamination site 10. The location of the treatment area 12 was selected due to its higher concentration of PFAS compounds relative to other areas considered. Additionally, it is located downstream of a main contamination area.

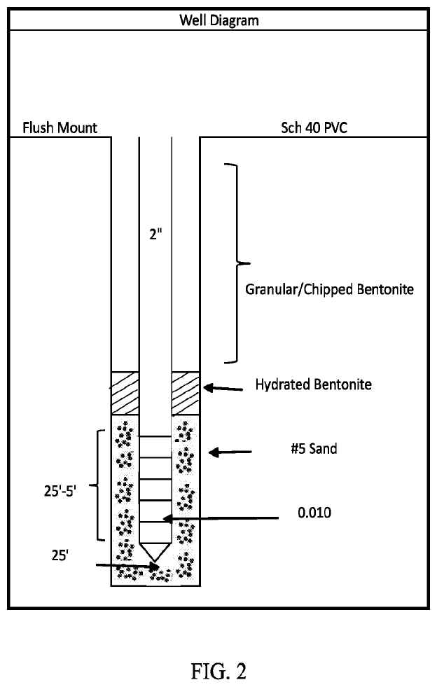

As shown in FIG. 1., the 40′×40′ treatment area 12 includes seventeen (17) injection points 16 and four (4) monitoring wells 20A-20D. Additionally, one can see the direction of groundwater flow via arrows 14, through the site 10 in a west-northwest to east-southeast direction with a flux rate of 0.5 to 0.9 ft/day. The monitoring wells 20A-20D were constructed as described in FIG. 2, in accordance with the NR141, and installed prior to the injection phase. These monitoring wells 20A-20D were used as extraction wells during the injection process. A vacuum truck applied a vacuum to the well creating a cone of depression. The cone of depression helps to counter the cone of impression that can result from injection activities and facilitate slurry distribution throughout the treatment area 12.

Direct push technology was used to form the seventeen (17) injection points 16. Each of the injection points 16 received a total of 200 gallons of treatment slurry composed of 12.8% wt/wt biochar, 1% wt/wt calcium peroxide, and two gallons of biological seeding solution.

An electokinetic system was placed in the center of the treatment area to facilitate the long-term production of oxygen from natural sources located within the formation, as well as, the injected calcium peroxide which is included to provide a short term oxygen increase and to maintain microbes during the injection. Six electrodes consisting of 2-inch black steel pipe were spaced 12-15 feet apart and are connected to a voltage source. Optionally the polarity of the voltage applied through the electokinetic system may alternate and/or pulse at a duration of 0.1 ms to 10 s A low operating voltage of approximately 1 to 100 volts, and preferably 10 to 40 volts is supplied throughout the electokinetic system. Optionally the electrokinetic system may further provide a low current density.

As shown in FIG. 1, monitoring well 20A is located in the center of the treatment zone and is the main focus of assessing treatment effectiveness. Monitoring wells 20B and 20D are located in areas that received much less treatment given their location about the perimeter of the treatment zone 12. Results from monitoring wells 20B and 20D are discussed below, but with the consideration that they are on the periphery of the treatment area 12. Monitoring well 20C is located directly downstream from the main treatment area 12 and is the beneficiary of receiving flow from the entire treatment zone. Note that initial concentrations are very similar for monitoring wells 20A, 20B, and 20D, and slightly less for monitoring well 20C.

b. Results
i. Monitoring Wells 20B and 20D

When evaluating monitoring wells 20B and 20D, in Tables 1 and Table 2 respectively, excellent reductions are achieved along the periphery of the treatment zone 12.

When considering monitoring well 20D it is important to note that monitoring well 20D has the smallest treatment area and was positioned on the upgradient edge of the injection area 12, upstream from the other monitoring wells. Despite that consideration, excellent reduction in all PFAS compounds during the testing period was recorded at monitoring well 20D.

While starting concentrations are very similar to monitoring well 20D, the additional treatment area in front of monitoring well 20B results in an improved reduction in PFAS compounds found during sampling events as can be seen in Table 2.

TABLE 1
PFAS concentrations from samples
taken from Monitoring Well 20D

| Analyte | | +34 | +51 | +65 | +98 | +126 |
|---|---|---|---|---|---|---|
| ng/l | Control | Days | Days | Days | Days | Days |
| PFBA | 390 | 360 | 460 | 460 | 380 | 390 |
| PFPeA | 1,500 | 670 | 1,600 | 1,400 | 1,400 | 1,400 |
| PFBS | 650 | 98 | 150 | 200 | 320 | 380 |
| 4:2 FTS | 51 | 5.8 J | 4 | 9 | 13 | 21 |
| PFHxA | 1,600 | 350 | 710 | 870 | 1,000 | 1,300 |
| PFPeS | 1,000 | 120 | 300 | 390 | 540 | 620 |
| PFHpA | 510 | 85 | 140 | 220 | 280 | 320 |
| PFHxS | 8,500 | 1,200 | 3,200 | 3,500 | 4,700 | 4,900 |
| 6:2 FTS | 3,100 | 710 | 2,200 | 2,300 | 2,600 | 2,200 |
| PFOA | 1,100 | 130 | 250 | 300 | 280 | 490 |
| PFHpS | 350 | 48 | 220 | 230 | 180 | 210 |
| PFNA | 93 | 13 J | 50 | 43 | 38 | 46 |
| PFOSA | 88 | | 8 | 11 | 41 | 29 |
| PFOS | 18,000 | 2,300 | 6700 E | 6,700 | 6,600 | 7,900 |
| PFDA | 7 | | | 5 | 7 | 6 |
| 8:2 FTS | 350 | 36 | 98 | 130 | 180 | 220 |
| PFNS | 0 | | 4 | | 11 | |
| NMeFOSAA | 0 | | | 1.3 J | 1.1 J | 1.3 J |
| PFUnA | 0 | | | 0.65 J | 1.6 J | |
| PFDS | 0 | | 8 | 9 | 34 | 6 |
| 10:2 FTS | 0 | | | | 1.2 J | 2.4 J |
| TOTAL | 37,289 | 6,126 | 16,103 | 16,778 | 18,607 | 20,441 |

TABLE 2
PFAS concentrations from samples
taken from Monitoring Well 20B

| Analyte | | +34 | +51 | +65 | +98 | +126 |
|---|---|---|---|---|---|---|
| ng/l | Control | Days | Days | Days | Days | Days |
| PFBA | 390 | 140 | 170 | 240 | 180 | 260 |
| PFPeA | 1,300 | 250 | 390 | 540 | 370 | 370 |
| PFBS | 560 | 57 | 180 | 250 | 170 | 160 |
| 4:2 FTS | 20 | | 14 | 20 | 13 | 8 |
| PFHxA | 1,400 | 120 | 360 | 570 | 390 | 410 |
| PFPeS | 880 | 32 | 190 | 300 | 210 | 39 |
| PFHpA | 380 | 17 J | 76 | 140 | 110 | 99 |
| PFHxS | 7,000 | 130 | 1,300 | 1,800 | 1,500 | 410 |
| 6:2 FTS | 1,400 | 41 J | 550 | 940 | 670 | 380 |
| PFOA | 560 | 21 | 200 | 240 | 180 | 140 |
| PFHpS | 410 | | 41 | 64 | 51 | 39 |
| PFNA | 170 | | 13 | 20 | 22 | 23 |
| PFOSA | 8 | | | | 0.81 J | 0.88 J |
| PFOS | 16,000 | 120 | 1,800 | 3,100 | 2,900 | 3,000 |
| PFDA | 0 | | | 0.74 J | 0.62 J | |
| 8:2 FTS | 150 | 0 | 36 | 46 | 50 | 38 |
| PFNS | 0 | | | 6 | | 5.4 I |
| TOTAL | 30,628 | 928 | 5,320 | 8,277 | 6,817 | 5,382 |

As shown in FIG. 1, monitoring well 20A is located in the center of the treatment zone 12. Table 3 demonstrates a reduction in PFAS compounds at monitoring well 20A, with orders of magnitude reductions for many. Additionally, a number of compounds are below reliable lab quantification for a significant period. Table 3 also demonstrates peak concentrations that are much lower than monitoring well 20B and 20D, demonstrating the treatment capacity of the increased treatment area upstream of monitoring well 20A.

TABLE 3
PFAS concentrations from samples
taken from monitoring well 20A

| Analyte | | +34 | +51 | +65 | +98 | +126 |
|---|---|---|---|---|---|---|
| ng/l | Control | Days | Days | Days | Days | Days |
| PFBA | 350 | 150 | 280 | 250 | 290 | 190 |
| PFPeA | 1,500 | 300 | 450 | 580 | 430 | 470 |
| PFBS | 610 | 5.9 J | 6 | 7 | 12 | 160 |
| 4:2 FTS | 50 | 0 | 0.7 J | 0.99 J | 1.1 J | 13 |
| PFHxA | 1,600 | 77 | 110 | 140 | 93 | 500 |
| PFPeS | 930 | 0 | 6 | 8 | 12 | 200 |
| PFHpA | 510 | 14 J | 18 | 26 | 19 | 190 |
| PFHxS | 6,900 | 29 | 43 | 43 | 86 | 1,800 |
| 6:2 FTS | 3,500 | 290 | 260 | 460 | 140 | 820 |
| PFOA | 1,500 | 7.8 J | 8 | 11 | 23 | 470 |
| PFHpS | 310 | 0 | 1.1 J | 0.98 J | 2 | 76 |
| PFNA | 73 | 0 | 0.65 J | 0.54 J | 0.99 J | 27 I |
| PFOSA | 18 | 6 J | 2 | 3 | 0.61 J | 0.51 J |
| PFOS | 14,000 | 100 | 79 | 94 | 150 | 4,400 |
| PFDA | 7 | 0 | | 0.53 J | | 3 |
| 8:2 FTS | 670 | 17 J | 6 | 11 | 8 | 260 |
| PFNS | 0 | | | | | 27 I |
| NMeFOSAA | 0 | | | | | 2 |
| 10:2 FTS | 0 | | | | | 0.92 J |
| TOTAL | 32,528 | 997 | 1,271 | 1,636 | 1,268 | 9,609 |

Monitoring well 20C, as shown in FIG. 1 is directly downstream from the treatment zone 12, which means it is an excellent representation of the ability of the treatment zone 12 to decrease PFAS concentrations as the groundwater moves through it. While the initial concentrations were lower than that of the other three wells 20A, 20B, 20D by roughly one-third, the concentration post treatment are more than commensurately lower. As can be seen in Table 4, total PFAS concentrations are reduced 2-3 orders of magnitude prior.

TABLE 4
PFAS concentrations from samples
taken from monitoring well 20C.

| Analyte | | +34 | +51 | +65 | +98 | +126 |
|---|---|---|---|---|---|---|
| ng/l | Control | Days | Days | Days | Days | Days |
| PFBA | 210 | 0 | 100 | 110 | 76 | 110 |
| PFPeA | 790 | | 45 | 70 | 33 | 230 |
| PFBS | 320 | | 2 | 5 | 1.5 J | 110 |
| 4:2 FTS | 37 | | | | | 4 |
| PFHxA | 950 | | 4 | 10 | 3 | 260 |
| PFPeS | 420 | | | 1.1 J | | 100 |
| PFHpA | 340 | | | 0.52 J | | 61 |
| PFHxS | 3,800 | | 0.84 J | 2 | 2 | 590 |
| 6:2 FTS | 2,600 | | | | | 120 |
| PFOA | 1,000 | | | 0.49 J | | 68 |
| PFHpS | 230 | | | | | 9 |
| PFNA | 44 | | | | | 3 |
| PFOSA | 0 | 11 J | | | | 0.7 J |
| PFOS | 12,000 | | 3 | 2 | 2 | 400 |
| PFDA | 6 | 7.5 J | | | | |
| 8:2 FTS | 860 | | | | | |
| PFNS | 0 | | | | | 3 |
| NMeFOSAA | 6 | | | | | |
| TOTAL | 23,613 | 19 | 155 | 202 | 117 | 2,068 |

The inventors propose that the main mechanism for breakdown of PFAS compounds used by the biological agents involved utilize calcium ions and inorganic fluoride ions to facilitate the cleaving of the carbon fluoride bonds in the PFAS compounds. Evidence for this mechanism can be found in Tables 5, 6, 7, and 8. Notably, there is a general decrease in calcium concentrations in monitoring wells 20A, 20C, and 20D, which are combined with a decrease in inorganic fluoride concentrations. These data support the conclusion that calcium fluoride is produced by the biota as product of defluorination by combining calcium and fluoride ions with the organic fluorine from the backbone of the PFAS compounds creating a stable fluoride salt. Furthermore, Adsorbable Organofluorine (AOF) concentrations can be seen rising in all samples.

AOF testing involves high temperature combustion on a combustion ion chromatogram. These tests can have difficulty detecting PFAS compounds due to their flame-resistant characteristics. The inventors propose that the emergence of measurable AOF indicates that the backbone of the PFAS compounds have been compromised as described above allowing the remaining fluorinated organic compounds to be oxidized by the AOF tests flame detection, i.e. those compounds are have been rendered flammable by the biological processes taking place.

Additionally, monitoring wells 20B and 20D have higher concentrations of AOF detected when compared to monitoring wells 20A and 20C. As described previously, monitoring wells 20B and 20D are on the periphery of the treatment zone 12 while monitoring wells 20A and 20C are near the center and near the “end” of the treatment zone 12. Monitoring wells 20C receives the full benefit of the entire treatment area. As a result, monitoring wells 20C has AOF concentrations that are lower than monitoring wells 20A, 20B and 20D. Generally, AOF concentrations are higher in monitoring wells with smaller treatment zones. Monitoring well 20D, having the smallest treatment zone has the highest concentrations. Monitoring well 20B, has lower concentrations. Monitoring well 20A lower concentrations and monitoring well 20C the lowest.

These results indicate that the larger treatment areas 12 associated with their respective wells 20 are capable of further degradation of fluorinated organic compounds that are being produced as byproducts in the biological process. Specifically Monitoring well 20D is the has the smallest treatment zone and results in the highest concentrations while Monitoring well 20C has the largest and has the lowest concentrations. Monitoring wells 20A and 20B produce concentrations commensurate with their having the second and third largest treatment zones, respectively. Further, proper treatment zone sizing would result is greatly reducing the potential for short chain fluorinated organic compounds to remain as a byproduct of treatment.

TABLE 5
Calcium, Fluoride, and AOF concentrations Monitoring Well 20A

| | Well 20A | | | | | | |
|---|---|---|---|---|---|---|---|
| | | +34 | +51 | +65 | +98 | +126 | +161 |
| Analyte | Control | Days | Days | Days | Days | Days | Days |
| Calcium | 110 | NS | 190 | 210 | 17 | 87 | 13 |
| (mg/L) | | | | | | | |
| Fluoride | 0.17 | NS | 0.03 J | 0.04 J | 0.04 | 0.1 | 0.05 J |
| (mg/L) | | | | | | | |
| AOF | 0 | NS | 0 | 12 | 2.7 | 13 | 9 |
| (ug/L) | | | | | | | |

TABLE 6
Calcium, Fluoride, and AOF concentrations Monitoring Well 20B

| | Well 20B | | | | | | |
|---|---|---|---|---|---|---|---|
| | | +34 | +51 | +65 | +98 | +126 | +161 |
| Analyte | Control | Days | Days | Days | Days | Days | Days |
| Calcium | 99 | NS | 99 | 99 | 99 | 91 | 90 |
| (mg/L) | | | | | | | |
| Fluoride | 0.2 | NS | 0.15 | 0.17 | 0.17 | 0.16 | 0.16 |
| (mg/L) | | | | | | | |
| AOF | 0 | NS | 0 | 7.7 | 10 | 11 | 18 |
| (ug/L) | | | | | | | |

TABLE 7
Calcium, Fluoride, and AOF concentrations Monitoring Well 20C

| | Well 20C | | | | | | |
|---|---|---|---|---|---|---|---|
| | | +34 | +51 | +65 | +98 | +126 | +161 |
| Analyte | Control | Days | Days | Days | Days | Days | Days |
| Calcium | 100 | NS | 3.4 | 81 | 160 | 58 | 75 |
| (mg/L) | | | | | | | |
| Fluoride | 0.18 | NS | 0.05 J | 0.05 J | 0.05 | 0.06 J | 0.09 J |
| (mg/L) | | | | | | | |
| AOF | 0 | NS | 0 | 1.7 | 1.6 | 8.5 | 3.5 |
| (ug/L) | | | | | | | |

TABLE 8
Calcium, Fluoride, and AOF concentrations Monitoring Well 20D

| | Well 20D | | | | | | |
|---|---|---|---|---|---|---|---|
| Analyte | | +34 | +51 | +65 | +98 | +126 | +161 |
| ng/l | Control | Days | Days | Days | Days | Days | Days |
| Calcium | 91 | NS | 48 | 53 | 62 | 69 | 68 |
| (mg/L) | | | | | | | |
| Fluoride | 0.2 | NS | 0.16 | 0.16 | 0.16 | 0.15 | 0.12 |
| (mg/L) | | | | | | | |
| AOF | 0 | NS | 0 | 22 | 28 | 28 | 9 |
| (ug/L) | | | | | | | |

### II. Example 2—Four Tote Trial

The inventors employed an embodiment of the invention to treat PFAS contaminated water in four 275 gallon IBU totes. Each tote contained water contaminated with AFFF foam.

The water was collected from firetruck tanks during clean out when switching from AFFF. Each of the totes had different initial total PFAS concentrations.

Each tote contained 275 gallons of contaminated water. Totes 1, 3, and 4 were treated with an embodiment of the invention while tote 2 only employed a biological treatment method. As used herein the biological treatment method include an inoculation of aerobic PFAS degrading bacteria strains, consisting of at least one of Pseudomonas, Rhodococcus, Pseudonocardia, Bacillus, Actinomycetota, and combinations thereof. All four totes were treated with 1 pound of calcium peroxide, 1 liter of biological seeding solution, and received a constant source of oxygen delivered via aquarium stones and aeration units.

Totes 1, 3, and 4 also received 135 pounds of biochar, such as described herein. An additional 45 pounds of biochar was added to totes 1, 3, and 4 at week 9 for a total of 180 pounds of biochar.

As can be seen in Table 9, Tote 2, biological treatment alone, reduced total PFAS concentrations by an order of magnitude. During the 26 week trial period the biological treatment scheme proved capable of gradual degradation of the PFAS compounds present.

Tote 4 was the most similar to Tote 2 in terms of total PFAS concentration and individual compound concentrations. As can be seen by comparing Table 9 to Table 10, when aided by the addition of biochar as per an embodiment of the invention, a the reduction in PFAS compounds is much faster and more complete. In Tote 4 a reduction by three orders of magnitude compared to one order of magnitude in Tote 2. While Totes 2 and 4 had differing initial concentrations, they were of the same order of magnitude. The significant increase in the reduction rate and magnitude of Tote 4 is clearly due to the effectiveness of the treatment method and not due to differences in initial concentration.

Tote 3 achieved five orders of magnitude in reduction, but also had a much lower initial concentration. Table 11 contains the resulting data.

Tote 1 had an initial concentration much higher than that of any of the other three totes. As can be seen in Table 12, even with a significantly higher initial concentration, total PFAS concentrations were reduced from greater than 33,000,000 ng/L to 200,000 ng/L, a 99% reduction in total concentration.

In conclusion, while Tote 2 demonstrates the capability of biological treatment to reduce PFAS concentrations, the embodiment of the invention applied here provides much faster and more complete elimination of PFAS compounds from the aqueous matrix.

TABLE 9
Tote 2 Biological treatment alone
TOTE 2 - PFAS Degrading Bacteria NO Biochar

| Analyte | | | | | | | | |
|---|---|---|---|---|---|---|---|---|
| ng/l | Control | Week 1 | Week 3 | Week 5 | Week 9 | Week 15 | Week 20 | Week 26 |
| PFBA | 160,000 | 192,000 | 168,000 | 179,000 | 199,000 | 32,000 | 490 | 27,000 |
| PFPeA | 733,000 | 795,000 | 691,000 | 685,000 | 773,000 | 150,000 | 160,000 | 150,000 |
| PFBS | 25,800 | 1,360,000 | 1,140,000 | 1,190,000 | 1,450,000 | 220,000 | 210,000 | 220,000 |
| 4:2 FTS | 12,400 | 10,300 | 8,230 | 9,520 | 13,100 | 2,800 | 1,100 | 3,100 |
| PFHxA | 251,000 | 308,000 | 274,000 | 304,000 | 313,000 | 66,000 | 86,000 | 64,000 |
| PFPeS | 17,200 | 0 | 0 | 0 | 0 | 2,100 | 3,500 | 790 |
| PFHpA | 11,100 | 9,260 | 0 | 6,790 | 6,470 | 1,500 | 1,600 | 490 |
| PFHxS | 166,000 | 19,600 | 0 | 7,540 | 9,350 | 1,800 | 2,300 | 630 |
| 6:2 FTS | 7,280,000 | 1,500,000 | 2,690,000 | 4,460,000 | 7,800,000 | 500,000 | 7,200 | 110,000 |
| PFOA | 18,600 | 0 | 0 | 0 | 0 | 550 | 920 | 93 |
| PFHpS | 12,700 | 0 | 0 | 0 | 0 | 61 | 36 | 65 |
| PFNA | 0 | 309,000 | 64,300 | 228,000 | 226,000 | 24,000 | 33,000 | 6,200 |
| PFOSA | 7,510 | 0 | 0 | 0 | 0 | 490 | 790 | 280 |
| PFOS | 1,060,000 | 185,000 | 52,300 | 155,000 | 136,000 | 27,000 | 38,000 | 16,000 |
| PFDA | 0 | 0 | 0 | 0 | 0 | 0 | 200 | 61 |
| 8:2 FTS | 18,800 | 0 | 0 | 8,860 | 0 | 1,800 | 1,800 | 1,900 |
| PFNS | 0 | 0 | 0 | 0 | 0 | 0 | 73 | 0 |
| PFUnA | 0 | 0 | 0 | 0 | 0 | 0 | 110 | 0 |
| PFDS | 0 | 0 | 0 | 0 | 0 | 0 | 87 | 0 |
| 10:2 FTS | 0 | 10,600 | 0 | 0 | 0 | 0 | 0 | 0 |
| PFDoA | 0 | 0 | 0 | 0 | 0 | 0 | 200 | 0 |
| PFTeDA | 0 | 0 | 0 | 0 | 0 | 0 | 450 | 0 |
| TOTAL | 9,774,110 | 4,698,760 | 5,087,830 | 7,233,710 | 10,925,920 | 1,030,101 | 547,856 | 600,609 |

TABLE 10
Tote 4 embodiment most directly comparable to biological only treatment
TOTE 4 - Biochar with PFAS Degrading Bacteria

| Analyte | | | | | | | | |
|---|---|---|---|---|---|---|---|---|
| ng/l | Control | Week 1 | Week 3 | Week 5 | Week 9 | Week 15 | Week 20 | Week 26 |
| PFBA | 122,000 | 79,600 | 69,600 | 60,000 | 7,590 | 2,700 | 2,300 | 2,700 |
| PFPeA | 220,000 | 47,700 | 37,000 | 20,900 | 0 | 490 | 280 | 480 |
| PFBS | 20,000 | 37,600 | 20,600 | 10,000 | 0 | 160 | 240 | 120 |
| 4:2 FTS | 9,420 | 0 | 0 | 0 | 0 | 1 | 1 | 0 |
| PFHxA | 199,000 | 0 | 0 | 0 | 0 | 35 | 52 | 27 |
| PFPeS | 12,600 | 0 | 0 | 0 | 0 | 1 | 1 | 0 |
| PFHpA | 8,100 | 0 | 0 | 0 | 0 | 2 | 4 | 0 |
| PFHxS | 85,100 | 0 | 0 | 0 | 0 | 4 | 8 | 0 |
| 6:2 FTS | 5,260,000 | 18,200 | 13,800 | 0 | 19,300 | 340 | 620 | 50 |
| PFOA | 19,000 | 0 | 0 | 0 | 0 | 2 | 3 | 0 |
| PFHpS | 13,700 | 0 | 0 | 0 | 0 | 0 | 0 | 0 |
| PFNA | 0 | 0 | 0 | 0 | 0 | 12 | 23 | 0 |
| PFOSA | 0 | 0 | 0 | 0 | 0 | 1 | 2 | 0 |
| PFOS | 602,000 | 0 | 0 | 0 | 0 | 28 | 63 | 6 |
| 8:2 FTS | 7,390 | 0 | 0 | 0 | 0 | 0 | 2 | 0 |
| MeFOSAA | 7,460 | 0 | 0 | 0 | 0 | 0 | 0 | 0 |
| 10:2 FTS | 6,500 | 0 | 0 | 0 | 0 | 0 | 0 | 0 |
| TOTAL | 6,592,270 | 183,100 | 141,000 | 90,900 | 26,890 | 3,775 | 3,600 | 3,383 |

TABLE 11
Resulting data from embodiment in Tote 3.
TOTE 3 - Biochar with PFAS Degrading Bacteria

| Analyte | | | | | | | | |
|---|---|---|---|---|---|---|---|---|
| ng/l | Control | Week 1 | Week 3 | Week 5 | Week 9 | Week 15 | Week 20 | Week 26 |
| PFBA | 18,900 | 0 | 0 | 0 | 0 | 19 | 11 | 28 |
| PFPeA | 47,600 | 0 | 0 | 0 | 0 | 6 | 7 | 0 |
| PFBS | 7,360 | 14,200 | 13,400 | 0 | 0 | 160 | 0 | 10 |
| PFHxA | 50,100 | 0 | 0 | 0 | 0 | 8 | 7 | 0 |
| PFPeS | 0 | 0 | 0 | 0 | 0 | 0 | 0 | 0 |
| PFHpA | 0 | 0 | 0 | 0 | 0 | 11 | 6 | 0 |
| PFHxS | 26,900 | 0 | 0 | 0 | 0 | 5 | 3 | 0 |
| 6:2 FTS | 1,130,000 | 0 | 21,400 | 12,300 | 0 | 380 | 330 | 0 |
| PFOA | 0 | 0 | 0 | 0 | 0 | 1 | 1 | 0 |
| PFNA | 0 | 19,300 | 18,100 | 8,800 | 0 | 460 | 330 | 0 |
| PFOSA | 0 | 0 | 0 | 0 | 0 | 0 | 1 | 0 |
| PFOS | 73,800 | 0 | 0 | 0 | 0 | 31 | 26 | 7 |
| 8:2 FTS | 0 | 0 | 0 | 0 | 0 | 2 | 2 | 0 |
| TOTAL | 1,354,660 | 33,500 | 52,900 | 21,100 | 0 | 1,084 | 725 | 45 |

TABLE 12
Resulting data from embodiment in Tote 1.
TOTE 1 - Biochar with PFAS Degrading Bacteria

| Analyte | | | | | | | | |
|---|---|---|---|---|---|---|---|---|
| ng/l | Control | Week 1 | Week 3 | Week 5 | Week 9 | Week 15 | Week 20 | Week 26 |
| PFBA | 356,000 | 333,000 | 318,000 | 309,000 | 329,000 | 44,000 | 36,000 | 46,000 |
| PFPeA | 1,090,000 | 1,130,000 | 945,000 | 1,050,000 | 823,000 | 140,000 | 88,000 | 100,000 |
| PFBS | 66,500 | 1,120,000 | 1,070,000 | 910,000 | 318,000 | 74,000 | 73,000 | 38,000 |
| 4:2 FTS | 46,100 | 41,700 | 44,000 | 34,200 | 16,300 | 590 | 350 | 160 |
| PFHxA | 1,170,000 | 978,000 | 813,000 | 834,000 | 385,000 | 40,000 | 29,000 | 17,000 |
| PFPeS | 54,700 | 28,000 | 16,600 | 10,300 | 0 | 720 | 680 | 120 |
| PFHpA | 19,800 | 25,900 | 20,600 | 17,900 | 0 | 210 | 160 | 54 |
| PFHxS | 345,000 | 67,800 | 25,500 | 12,500 | 0 | 170 | 110 | 16 |
| 6:2 FTS | 27,100,000 | 9,460,000 | 2,690,000 | 1,450,000 | 119,000 | 1,800 | 2,200 | 190 |
| PFOA | 50,700 | 14,600 | 0 | 0 | 0 | 10 | 9 | 0 |
| PFHpS | 43,200 | 11,600 | 0 | 0 | 0 | 0 | 0 | 0 |
| PFNA | 0 | 41,400 | 8,280 | 7,460 | 0 | 21 | 87 | 0 |
| PFOS | 2,790,000 | 630,000 | 8,400 | 6,870 | 0 | 16 | 110 | 6 |
| 8:2 FTS | 32,100 | 7,700 | 0 | 0 | 0 | 0 | 0 | 0 |
| MeFOSAA | 15,800 | 0 | 0 | 0 | 0 | 0 | 0 | 0 |
| 10:2 FTS | 29,500 | 14,500 | 0 | 0 | 0 | 0 | 0 | 0 |
| TOTAL | 33,209,400 | 13,904,200 | 5,959,380 | 4,642,230 | 1,990,300 | 301,537 | 229,706 | 201,546 |

### III. Example 3—Treatment of Former Tannery

Test site is a former tannery which operated from the 1890s to the 1950s. The former tannery buildings burned to the ground in 2005. Prior use of Aqueous Film Forming Foam (AFFF) at the tannery site is suspected. PFAS has been detected on site in both soil and groundwater at levels that exceed applicable drinking water and groundwater surface water interface (GSI) criteria. Municipal water is available in the area, and the principal risk associated with PFAS at this site is migration of PFAS to the adjacent river and lake. Seasonally, PFAS impacted groundwater has vented to the ground surface and the former tannery's storm water infrastructure.

Test procedure performed on site have included the injection and mechanically mixed biochar to immobilize PFAS in the impacted, unconsolidated shallow groundwater at the site to test the capability of phytoremediation of PFAS impacted groundwater using a combination of strategies. Biochar was mixed at 8% by volume of soil and dispersed into 8 foot wide trenches in the ground at the saturation zone. Tree species were planted overtop of the trenches with a sleeve disposed about the rhizosphere of each tree as to isolate the rhizosphere from the surrounding vadose soil and rainwater seepage. The sleeve is not water permeable, thereby forcing the tree uptake PFAS impacted groundwater through the open bottom end of the sleeve. A cap or seal is placed around the tree at the surface to prevent rainwater infiltration-thereby forming a controlled bioreactor about the isolated treewell that uptakes PFAS impacted groundwater. Biochar and microbes were added to the bioreactors. Groundwater samples for the bioreactors and tree tissue samples were periodically analyzed. Results demonstrate significant reduction in PFAS, and at least below applicable drinking water and ground surface waster interface (GSI) criteria, as to demonstrate that utilizing biochar combined with or without microbes can stop and/or significantly reduce the uptake of PFAS (and likely other contaminates) into trees and plants. And thereby reduce the spread of PFAS into the environment and the food chain of people and animals.

More specifically, in a control tree, i.e., bioreactor, the bioaccumulation of PFAS in a leaf tissue during a testing period, consisting of 30 days, was equal to approximately 88 ng/g in total wherein the identified PFAS are selected from a list including Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In contrast, in six experimental trees, i.e., bioreactors, the bioaccumulation of PFAS in a leaf tissue during a testing period, consisting of 30 days, was recorded and identified as less than or equal to 4.0 ng/g PFAS in average. That is to say the experimental bioreactors exhibited a greater than 95% reduction in PFAS compared to the control. Furthermore, the experimental bioreactors exhibited a greater than 85% reduction in PFHxS, and PFOS, and a nondetectable, i.e., greater than 99% reduction in PFHpS, PFPeS, PFBS, PFOA, PFHzA, PFPeA, and combinations thereof.

Furthermore, in the control tree, i.e., bioreactor, the bioaccumulation of PFAS in groundwater sampled from within the bioreactor during a testing period, consisting of 30 days, was equal to approximately 23 μg/g, in total wherein the identified PFAS are again selected from a list including Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In contrast, in six experimental trees, i.e., bioreactors, the bioaccumulation of PFAS in a groundwater sampled from within the bioreactors during a testing period, consisting of 30 days, was recorded and identified as less than or equal to 2.0 μg/g PFAS in average. That is to say the experimental bioreactors exhibited a greater than 91% reduction in PFAS compared to the control. Furthermore, the experimental bioreactors exhibited a greater than 85% reduction in PFHxS, and PFOS, and a nondetectable, i.e., greater than 99% reduction in PFHpS, PFPeS, PFBS, PFOA, PFHZA, PFPeA, and combinations thereof.

In another embodiment, the pH of the groundwater of the experimental bioreactors was controlled during a testing period of 30 days. A first group of three experimental bioreactors have a bioreactor pH of between 6.5 and 7.0. A second group of five experimental bioreactors have a bioreactor pH of greater than 9.0. After a 30 day test period, while both groups exhibited a greater than greater than 91% reduction in PFAS (μg/L) in groundwater, the first group having a bioreactor pH of between 6.5 and 7.0 exhibited a greater than 98% reduction of PFAS (g/L) in groundwater and did not exceed applicable regulatory concentration threshold

In sum, the biochar and microbial treatment of the test bioreactors was determined to be successful in combination with phytoremediation. Biochar and mircorbial treatments immobilize PFAS and reduce flux into the plant rhizosphere, while the tree simultaneously captures mobile short chain compounds, i.e., (C<4). In addition, groundwater samples achieved regulatory concentration compliance via the reduction of PFAS after 30 days in bioreactors with a pH of 6.5-7.0.

### IV. Example 4—Perchloroethylene Remediation

The inventors recommend utilizing the preferred treatment chemistry combination of biochar and a perchloroethylene or tetrachloroethylene (PCE) degrading microbial culture, including but not limited to an aerobic methanotrophic bacteria, and cultures including in-part aerobic methanotrophic bacteria. Due to the treatment area being an active business, methane generation and infiltration is a reasonable concern. Incorporating an aerobic microbial component removes the risk of methane generation that traditional treatment chemistries offer. The microbes paired with biochar, provide sustained vapor mitigation with contaminant reduction.

### A. DPT Injection Methodology

The remedial approach is the injection of the preferred treatment chemistry through a series of borings spaced in a grid-like pattern. The borings are advanced to the appropriate depth using DPT. The treatment chemistry is injected into the rods to create minimal positive pressure before commencing injection into the surrounding formation. The rods are then raised through the vertical treatment zone while simultaneously injecting the treatment chemistry into the formation.

The system utilizes approximately one to three-foot lift intervals throughout each vertical treatment location and injects the appropriate amount of treatment chemistry into each interval. The amount of treatment chemistry is administered according to the subsurface and known contamination characteristics. Immediately after the completion of each injection point, the borehole are backfilled and hydrated using bentonite crumbles and/or chips to prevent subsequent treatment chemistry short circuiting.

### B. Chemical Mixing and Delivery Methodology

The remedial injection treatment slurry, i.e, biochar and a perchloroethylene (PCE) degrading microbial culture, is mixed and temporarily staged prior to injection in 200-gallon tanks located inside Inventors' enclosed injection trailer. The tank is first filled with the proper amount of water to achieve the appropriate treatment chemistry solution concentration of preferably 0.5-25%, and more preferably 2.5-15% treatment chemistry by volume. The treatment chemistry will be pumped into the formation using an air-driven, chemically resistant pump. The rate, pressure, and volume will be monitored using a chemically resistant inline electronic flow meter.

Biochar, i.e. bioavailable absorbent media, is a sustainable, pyrolized, recycled cellulosic bio-mass product (>80% fixed carbon) derived from a blend of recycled organic materials with a high cation exchange, is described above in further detail. Biochar according to the present invention has diverse pore sizes with a total surface area of 900-1,500 square meters per gram and more preferably 1,000 to 1, 2500 square meters per gram.

The biochar of the present invention has numerous synergistic qualities for remediation purposes. That is to say that the biochar has the ability to provide ample usable surface area for maximizing microbial colonization and thereby an active microbial community. Due to its unique ‘honeycomb’ structure, the biochar of the present invention has the ability to provide increased pore space for the different strains of microbes. And, the biochar of the present invention's affinity for organic and inorganic compounds supports maximum contact (bioavailability through high sorbency) with microbes allowing for complete degradation.

The unique absorption capability of biochar prevents exterior surface microfilm buildup providing long term remediation capabilities. This allows the biochar of the present invention to absorb contaminants for more productive bio-attenuation of contaminants over a longer period of time. In contrast, activated carbons, such as granular activated carbon (GAC) primarily adsorbs contamination to the surface of the media, which then is subject to bio-film development, preventing further adsorption. As a result, the biochar of the present invention has been shown to supply long term maintenance free remedial abilities over GAC. Laboratory tests have also shown that biochar has a significantly higher absorptive capacity than commercially available GAC products.

Pseudomonas and Bacillus species are PCE degrading bacteria that may specifically target PCE and associated daughter products. Such species of PCE degrading bacteria work to aerobically destroy PCE compounds without risk of methane generation. The aerobic pathway also avoids the accumulation of degradation products like vinyl chloride since these tend to degrade quickly in aerobic conditions.

### C. Chemical Remediation Application

In one embodiment of remediating a commercial dry-cleaning facility, remedial treatment utilizes DPT with a cart-probe to facilitate injection work inside. The vertical extent of remediation shall extends from approximately 7 to 14-ft below ground surface. Approximately 20-30 injection locations are utilized targeting the floor drains, dry cleaning machines, and sanitary sewer line. An average of 70 gallons of 9.5% biochar and PCE Degrading Microbe Solution by volume was injected into each of the approximately 25 injection points. Concentration, volume, and number of locations may vary depending on site conditions and contaminant load at each area.

Results demonstrate significant complete aerobic pathway destruction of chlorinated compounds, i.e., greater than 97% reduction by volume as compared to pretreated soil samples, as to demonstrate that utilizing biochar combined with PCE degrading microbes can stop or significantly damage the aerobic pathway of chlorinated compounds in the absence of methane generation.

### V. Example 5—Dry Cleaning Remediation

The treatment location is a dry cleaning operation located within a large industrial warehouse. A combination of BAM and aerobic microbes, such as those describing in Examiner 4, were injected below an existing building for treatment of Tetrachloroethylene (PCE) in soils and groundwater. The electrolysis system, such as that described in Example 1, was utilized to sustain aerobic condition for microbial growth. Baseline soil samples were collected in 7 foot bags in the center of the soil plume. Post injection soil samples were collected 3 months after treatment was begun from the same location.

Initial treatment site conditions include soil contaminant Tetrachloroethene (PCE) at 3.990 mg/kg, groundwater contaminant PCE at 160 mg/L. The impacted matrix was composed of a clay till. The applied treatment chemistry included biochar, aerobic microbes, and electrolysis system.

TABLE 13

| Soil Sample Results of Example 5 | | | | |
|---|---|---|---|---|
| Soil Sample Results | | | | |
| | Pre-Treatment | Post- Treatment | | |
| Sample Date | (Day 0) | (Day 92) | Δ | |
| Sample Depth (ft) | 7 | 7 | | |
| Units | mg/kg | mg/kg | % | |
| Chlorobenzene | 0.17 | 0.012 | 92.9 | (decrease) |
| 1,2-Dichloroethene(cis) | 5.49 | 9 | 63.9 | (increase) |
| 1,2-icholorthene (trans) | 0.25 | 0.27 | 8.0 | (increase) |
| Tetrachloroethene | 3990 | 84 | 97.9 | (decrease) |
| Trichloroethene | 5.13 | 12 | 134 | (increase) |
| Vinyl Chloride | <0.1 | <0.0003 | 99.7 | (decrease) |

TABLE 14
Groundwater Sample Results of Example 5
Groundwater Sample Results

| | Pre-Treatment | Post- Treatment | Post-Treatment | A (Day 1 to |
|---|---|---|---|---|
| Sample Date | (Day 0) | (Day 14) | (Day 63) | Day 62) |
| Units | mg/L | mg/L | mg/L | % (decrease) |
| Chlorobenzene | 0.014 | 0.0028 | <0.0005 | >96.4 |
| Chloroform | 0.0045 | 0.0024 | 0.00051 | 88.7 |
| 1,1-dichloroethane | 0.0016 | 0.001 | <0.0005 | >68.7 |
| 1,1-dichloroehtene | 0.011 | 0.005 | <0.0005 | >95.5 |
| 1,2- | 8.9 | 3.8 | 0.0072 | >99.9 |
| Dichloroethene(cis) | | | | |
| 1,2-icholorthene | 0.25 | 0.079 | <0.0005 | >99.9 |
| (trans) | | | | |
| Tetrachloroethene | 160 | 31 | 0.09 | 99.9 |
| Trichloroethene | 6.6 | 2.1 | 0.008 | 99.9 |
| Vinyl Chloride | 0.0013 | 0.00082 | <0.0005 | >61.5 |

Post injection reduction for PCE in soil are greater than 97% and in groundwater, greater than 99%. The aerobic breakdown pathway limits the formation of TCE and DCE when compared to reductive dichlorination. The process also accelerates vinyl chloride destruction which can be measured by a stubborn energy intense last step before ethene is formed. The combination of biochar and aerobic microbes provides an environmentally friendly alternative to harsh oxidants and methane forming reductive agents.

It should be understood that the invention is not limited in its application to the details of construction and arrangements of the components and method steps set forth herein. The invention is capable of other embodiments and of being practiced or carried out in various ways by those skilled in the art. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A method of contamination remediation comprising the steps of:
forming a treatment zone in a contaminated area containing an initial concentration of a perfluoroalkyl and/or polyfluoroalkyl substances (PFAS) and/or a perchloroethylene (PCE) contaminate, the treatment zone defined by an introduction of treatment slurry comprising biochar and an aerobic contaminate degrading bacteria additive;
supplying the treatment zone with an oxygen source:
concentrating the contaminate at the surface of the biochar located in the treatment zone; and,
degrading the contaminate at the surface of the biochar with the aerobic contaminate degrading bacteria additive to generate a final concentration of the contaminate that is less than the initial concentration.

2. The method of claim 1, wherein the oxygen source is selected from a group consisting of peroxygens and/or oxygen electrically generated via electrodes placed within the treatment zone, air sparging, gas diffusion or a combination thereof.

3. The method of claim 1, wherein the PFAS is selected from a group consisting of Perfluorooctane sulfonic (PFOS), acid Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof.

4. The method of claim 1, wherein the aerobic contaminate degrading bacteria additive is selected from a group consisting of Pseudomonas, Rhodococcus, Pseudonocardia, Bacillus, Actinomycetota, and combinations thereof.

5. The method of claim 4, wherein the aerobic contaminate degrading bacteria additive bacteria comprises at least in-part an aerobic methanotrophic bacteria.

6. The method of claim 1, wherein treatment slurry comprises from 10-15 wt % biochar based on the total weight of the treatment slurry.

7. The method of claim 1, wherein the biochar is formed of a plurality of particles having a net surface area of greater than or equal to 900 square meters per gram and less than or equal to 1,500 square meters per gram and wherein the particles have a particle size of between 0.5 microns and 4000 microns.

8. The method of claim 7, wherein the treatment slurry is a dilution comprising between 7.5% and 12.5% biochar and an aerobic contaminate degrading bacteria additive suspended in a fluid carrier based on the total volume of the slurry.

9. The method of claim 1, wherein the final concentration of the contaminate is less than 5% of the initial concentration.

10. The method of claim 5, wherein the final concentration of the contaminate is less than 3% of the initial concentration.

11. The method of claim 5, wherein the final concentration of the contaminate is less than 1% of the initial concentration.

12. The method of claim 1, wherein the treatment zone is an in situ treatment zone.

13. The method of claim 8, wherein the treatment zone defines a bioreactor further comprising a tree planted in the treatment zone.

14. The method of claim 1, including the step of providing one or more additives to the treatment slurry selected from the group consisting of a growth substrate, biological nutrient media, one or more anaerobic microbial agent, and a secondary oxidizing agent

15. A system for use in the remediation of an organic contaminant comprising:
a treatment application having:
a biochar formed of a plurality of particles having a net surface area of greater than or equal to 900 square meters per gram and less than or equal to 1,500 square meters per gram, wherein the particles have a particle size of between 0.5 microns and 4000 microns,
an aerobic contaminate degrading bacteria selected from a group consisting of Pseudomonas, Rhodococcus, and Pseudonocardia, Bacillus, Actinomycetota, combinations thereof,
an oxygen source selected from a group consisting of peroxygens and/or oxygen electrically generated via electrodes placed within a treatment zone, air sparging, gas diffusion or a combinations thereof, wherein the oxygen source is configured to maintain aerobic conditions in the treatment zone; and
wherein the treatment application is configured to degrade an initial concentration of a perfluoroalkyl and/or polyfluoroalkyl substances (PFAS) and/or a perchloroethylene (PCE) contaminate in the treatment zone to a final concentration that is less than 5% of the initial concentration.
